(19) United States
(12) Patent Application Publication
(10) Pub. No.: US 2011/0074924 A1
(43) Pub. Date: Mar. 31, 2011

(54) VIDEO SIGNAL WITH DEPTH INFORMATION

(75) Inventors: Bart Gerard Bernard Barenbrug, Eindhoven (NL); Waltherus Antonius Hendrikus Roelen, Eindhoven (NL)

(73) Assignee: KONINKLIJKE PHILIPS ELECTRONICS N.V., EINDHOVEN (NL)

(21) Appl. No.: 12/993,865

(22) PCT Filed: May 27, 2009
(86) PCT No.: PCT/IB09/52225

§ 371 Date: Nov. 22, 2010

(30) Foreign Application Priority Data
Jun. 2, 2008 (EP) 08157420.4

(51) Int. Cl. H04N 13/00

(52) U.S. Cl. 348/43; 348/E13.001

(57) ABSTRACT

A system (100) for generating a signal (1300) representing a three dimensional scene from a primary view, comprising a sequence generator (104) for generating a sequence of stripes defining at least part of the representation of the three dimensional scene from the primary view and a signal generator (106) for generating a video signal comprising the sequence of stripes. Each stripe in turn represents a rectangular area of image information comprising data elements defining a color, a depth and a position of the rectangular area of image information, wherein the color and depth data elements for each stripe are derived from surface contour information of at least one object in the scene and the position data element is derived from the position of the surface contour information of the at least one object within the primary view. In this signal at least one stripe of the sequence of stripes represents surface contour information of the at least one object selected from an occluded area or a side area of the at least one object in the scene.

### FIELD OF THE INVENTION

The invention relates to a video signal with depth information. The invention also relates to methods and systems for generating a video signal with depth information and rendering a video signal with depth information.

### BACKGROUND OF THE INVENTION

Since the introduction of display devices, a realistic 3-D display device has been a dream for many. Many principles that should lead to such a display device have been investigated. One such principle is a 3-D display device based on binocular disparity only. In these systems the left and right eye of the viewer perceives another perspective and consequently, the viewer perceives a 3-D image. An overview of these concepts can be found in the book “Stereo Computer Graphics and Other True 3-D Technologies”, by D. F. McAllister (Ed.), Princeton University Press, 1993. For example, shutter glasses may be used in combination with for instance a CRT. If the odd frame is displayed, light is blocked for the left eye and if the even frame is displayed light is blocked for the right eye.

Display devices that show 3-D without the need for additional appliances such as glasses are called auto-stereoscopic display devices. For example multi-view auto-stereoscopic display devices have been proposed. In the display devices as disclosed in U.S. Pat. No. 6,064,424 a slanted lenticular is used, whereby the width of the lenticular is larger than two sub-pixels. In this way there are several images next to each other and the viewer has some freedom to move to the left and right. Other types of auto-stereoscopic display devices are known in the art.

In order to generate a 3-D impression on a multi-view display device, images from different virtual viewpoints have to be rendered. This requires either multiple input views or some 3D or depth information to be present. This depth information can be recorded, generated from multi-view camera systems or generated from conventional 2D video material. For generating depth information from 2D video several types of depth cues can be applied: such as structure from motion, focus information, geometric shapes and dynamic occlusion. Preferably a dense depth map is generated, i.e. per pixel a depth value. This depth map is subsequently used in rendering a multi-view image to give the viewer a depth impression.

Existing video connections are designed to exchange sequences of images. Typically the images are represented by two-dimensional matrices of pixel values at both sides of the connection, i.e. the transmitter and receiver. The pixel values correspond to luminance and/or color values. Both transmitter and receiver have knowledge about the semantics of the data, i.e. they share the same information model. Typically, the connection between the transmitter and receiver is adapted to the information model. An example of this exchange of data is an RGB link. The image data in the context of transmitter and receiver is stored and processed in a data format comprising triplets of values: R (Red), G (Green) and B (Blue) together forming the different pixel values. The exchange of the image data is performed by means of three correlated but separated streams of data. These data streams are transferred by means of three channels. A first channel exchanges the Red values, i.e. sequences of bits representing the Red values, the second channel exchanges the Blue values and the third channel exchanges the Green values. Although the triplets of values are typically exchanged in series, the information model is such that a predetermined number of triplets together form an image, meaning that the triplets have respective spatial coordinates. These spatial coordinates correspond to the position of the triplets in the two-dimensional matrix representing the image. Examples of standards, which are based on such an RGB link, are DVI (digital visual interface), HDMI (High Definition Multimedia Interface) and LVDS (low-voltage differential signaling). However in the case of 3-D, along with the video data, the depth related data has to be exchanged too.

WO 2006/137000 A1 discloses a method of combined exchange of image data and further data being related to the image data, such as depth data, the image data being represented by a first two-dimensional matrix of image data elements and the further data being represented by a second two-dimensional matrix of further data elements. The method comprises combining the first two-dimensional matrix and the second two-dimensional matrix into a combined two-dimensional matrix of data elements. The above method however is somewhat limited with respect to the information provided and may not provide sufficient information for accurate rendering.

### SUMMARY OF THE INVENTION

It would be advantageous to have an improved way of exchanging image data. To better address this concern, in a first aspect of the invention a system is presented for generating a signal representing a three dimensional scene from a primary view, comprising:
a sequence generator for generating a sequence of stripes defining at least part of the representation of the three dimensional scene from the primary view, each stripe representing a rectangular of image information comprising data elements defining a color, a depth and a position of the rectangular area, wherein the color and depth data elements for each stripe are derived from surface contour information of at least one object in the scene; the position data element is derived from the position of the surface contour information of the at least one object within the primary view and at least one stripe of the sequence of stripes represents surface contour information of the at least one object selected from an occluded area or a side area of the at least one object in the scene; and
a signal generator for generating a video signal comprising the sequence of stripes.

Each stripe corresponds to a rectangular area of image information within the primary view, thus a stripe may correspond to a single pixel, a one-dimensional array of pixels in the form of a line, or a two-dimensional array of pixels. Thus although a stripe corresponds to a rectangular area of image information, due to the inclusion of depth elements, the actual data represented by the stripe can describe a three-dimensional structure.

Since the stripes comprise data elements indicative of the position of the rectangular area of image information within the primary view, it becomes possible to more flexibly accommodate occlusion or side area information into the video signal. Any information about portions of the scene that might be available to the system can be inserted into one or more of such stripes. The video-like characteristics of the signal can be preserved to a large extend, because the stripes comprise familiar data elements indicative of color and depth. Consequently, these data elements may be encoded in a way known in the art of video encoding. This allows addressing backwards compatibility issues. It also allows applying standard video compression methods for information comprised within a stripe.

Since the stripes comprise data elements indicative of the position of the stripe, which may be in the form of data elements comprised in tuples of color, depth and position, it becomes easy to vary the sampling density between stripes or within a stripe. This enables inclusion of image information for occluded and/or side areas in the video signal. Also, the portions of an object which are close to parallel to a viewing direction of the primary view may be stored with improved resolution. These side areas may be occluded or poorly defined in a conventional image coded for the primary view. Consequently the improved resolution in which these portions are stored may be used to generate stereoscopic views with improved recovery of such side object portions.

Information of rear areas may also be included to further enhance the stereoscopic views. Information of rear areas also improves the possibility to look around objects: the scene may be viewed from very different perspectives, for example to allow a viewer to virtually move through the scene.

As indicated above a stripe defines a rectangular area of image information within the primary view, here rectangular area is understood to comprise rectangular areas comprising two-dimensional areas, one-dimensional areas, and/or points. An example of a two dimensional area is a rectangular array of equidistant samples, an example of a one-dimensional area would be a one-dimensional array of equidistant samples.

It should be noted that a stripe, although it a rectangular area of image information within the primary view, may actually comprise more information from the underlying three-dimensional scene than visible within the primary view. This is in fact the strength of the stripe representation, for this additional information may become visible when a different view is rendered.

A one-dimensional, line-based representation has the advantage that is enables representation of more erratic shaped objects without unnecessary storage loss. Whereas a two-dimensional, i.e. multi-line based representation has the advantage that it enables improved compression of stripe data as spatial redundancy within a stripe can be exploited using e.g. block based compression schemes.

The data elements can be grouped as tuples comprising color, depth and position data elements. In case color and depth are represented at one and the same resolution a representation using tuples (rgb, z, p) may be used, comprising red, green and blue-values representing a pixel color data element, a z-value representing a pixel depth data element and a p-value representing a pixel position data element.

In case the depth information is subsampled and represented at a quarter of the color resolution a representation using tuples (rgb₁ , rgb₂ , rgb₃ , rgb₄, z, p) may be used. It will be clear to the skilled person that the use of RGB data elements is merely exemplary and other color data elements such as YUV, or subsampled YUV (4:2:0) can be used instead. In the preceding tuple a single p-value and z-value are used to indicate the position of both the color and depth information, wherein the actual position of the color and depth data-elements can be derived from the p-value. When using line based stripes the p-value may represent an offset along the line relative to the start of the line. However in case of multi-line stripes the p-value itself may represent both an x and y coordinate, or alternatively a line number and an offset relative to the start of the line.

The above examples only comprise a single p-value for all coordinates. Alternatively when bandwidth/storage is less critical, more elaborate tuples such as:

(rgb₁,rgb₂,rgb₃,rgb₄,z,p_{rgb1234},p_{z}) (1)

(rgb₁,rgb₂,rgb₃,rgb₄,z,p_{rgb13},p_{rgb24},p_{z}), (2)

(rgb₁,rgb₂,rgb₃,rgb₄,z,p_{rgb1},p_{rgb2},p_{rgb3},p_{rgb4}) (3)

(rgb₁,rgb₂,rgb₃,rgb₄z,p_{rgb13},p_{rgb24}), or (4)

(rgb₁,rgb₂,rgb₃,rgb₄,z,p_{rgb1},p_{rgb2},p_{rgb3},p_{rgb4},p_{z}) (5)

may be used wherein position information is provided for more and/or for all individual color and depth data-elements.

For example, tuple (1) above includes two p-values, one for the color data-element and one for the depth data-element. Tuple (2) in turn represents a situation where the color data-elements are spread over two lines, and wherein the color sample points 1 and 2 are on the top line, and sample points 3 and 4 are located directly below on the bottom line. As the points 1 and 3 have the same offset within their respective line, a single p-value here suffices. The tuples (3) and (4) in turn do not comprise a separate p-value for the depth data-element. In the tuples (3) and (4) the p-value for the depth data-element is derivable from the p-values of the color data-elements. Finally tuple (5) allows full control of the position of sampling points within the rectangular area of image information within the primary view.

The signal may be split into a first subset of tuples representing samples corresponding to stripes representing an image of the three dimensional scene from the primary view, and a second subset comprising stripes representing occlusion and side area information. As a result the color data elements of the first subset can be coded as a first data stream and the depth data elements of the first subset can be coded as a second data stream.

In this manner compatibility with conventional three dimensional scene representations such as image-and depth can be achieved. The color, depth and position data elements of the occlusion or side area information in turn may be coded in a single stream, or in multiple streams.

The independent claims define further aspects of the invention. The dependent claims define advantageous embodiments.

### BRIEF DESCRIPTION OF THE DRAWINGS

These and other aspects of the invention will be further elucidated and described with reference to the drawing, in which

FIG. 1 is a block diagram illustrating aspects of a system for generating a video signal and a display system;

FIG. 2A shows a flow chart of a method of generating a video signal;

FIG. 2B shows a flow chart of a method of rendering a video signal;

FIG. 3 illustrates objects in a scene;

FIG. 4 illustrates portions of a scene visible from a primary viewing angle;

FIG. 5 illustrates a second layer of portions of a scene occluded in a primary view;

FIG. 6 illustrates portions of a scene that may be captured using a sequence of stripes;

FIG. 7 illustrates another example of portions of the scene that may be captured using a sequence of stripes;

FIG. 8 illustrates several views of a scene;

FIG. 9 illustrates a hardware architecture;

FIG. 10A illustrates a three-dimensional scene and camera viewpoint;

FIG. 10B illustrates a sequence of stripes according to the present invention wherein image information from side areas is interleaved with stripes representing the front view image;

FIG. 10C illustrates a sequence of stripes according to the present invention wherein image information from side areas is coded separate from the front view image;

FIG. 11 illustrates a line-based video image;

FIG. 12A illustrates an intersection of a three-dimensional scene along a video line;

FIG. 12B illustrates contour lines along a video line;

FIG. 13 illustrates a sequence of points along a contour line;

FIG. 14 illustrates a video stream; and

FIG. 15 illustrates another video stream.

### DETAILED DESCRIPTION OF EMBODIMENTS

In recent years, much effort has been put in the development of 3D displays and data representations suitable to drive such displays. Auto-stereoscopic 3D displays do not require the viewer to wear special eyewear (such as the red/green glasses), but usually rely on displaying more than two views which allow users to freely look around the scene which is displayed and perceive depth because their left and right eyes “see” two of these different views. Since displays can vary in the number of views displayed, and also in other attributes, such as the depth range they can portray, a data format which is independent of such differences is needed. The image-and-depth format has been adopted in MPEG-C part 3.

While the image-and-depth format is suitable for the first generation 3D displays, which have moderate depth range capabilities, it needs to be extended in order to allow for more look-around and less so-called occlusion artifacts. However, occlusion artifacts may also occur in the further generations of 3D displays, which would advantageously be removed by using an improved image-and-depth format.

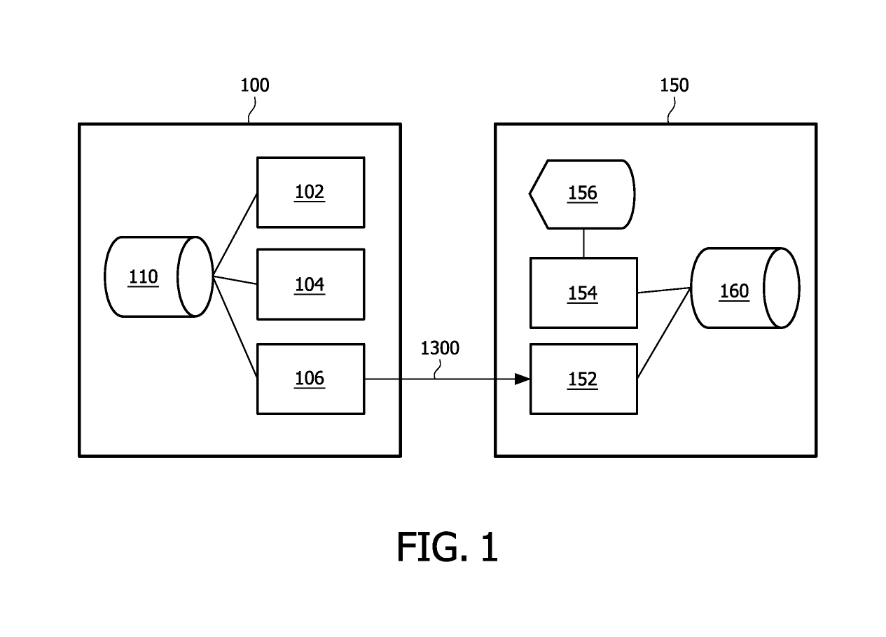

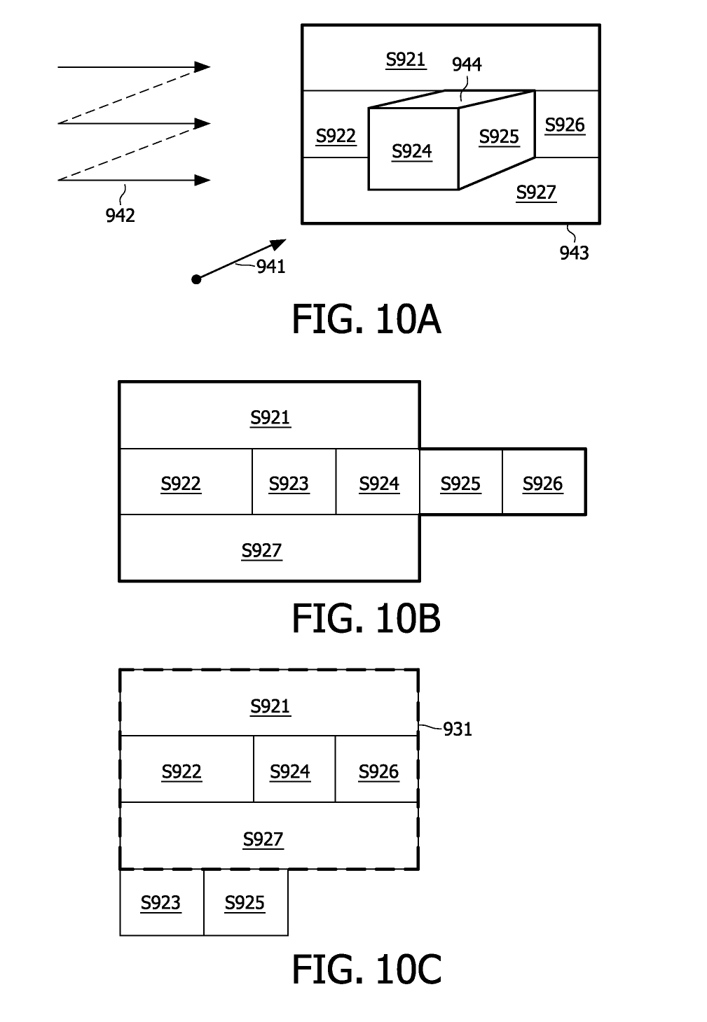

FIG. 1 illustrates a system 100 for generating a signal 1300 representing a three dimensional scene from a primary view and a display system 150 for receiving the signal and displaying the scene, from the same or another viewpoint. Several aspects of the signal are illustrated in FIGS. 10-15, to which reference will be made in the description of the systems 100 and 150. The system 100 may for example be implemented in a DVD mastering system, a video broadcasting system, or a video editing system. The display system 150 may be for example a television set, for example an LCD display or a plasma display. The display system may have stereoscopic capabilities, for example in combination with shutter glasses. The display system may also be an autostereoscopic display, for example comprising slanted lenticulars, as known in the art. The display system may also be a 2D display. Such a 2D display system may provide a 3D impression by rotating the objects being displayed. Also, more elaborate freedom to adapt the viewpoint may be provided by the 2D or 3D display system 150 allowing the user to move through the scene.

FIG. 10A illustrates schematically a three dimensional scene comprising a cube 944 positioned in front of a background plane 943 that is imaged from a viewpoint along a view direction as indicated by arrow 941, hereafter referred to as the primary view. As the arrow 941 is perpendicular to the background plane and to the front of the cube, the pixels in a two-dimensional image perceived for this primary view would consists of rectangular areas of image information corresponding to parts of the background plane S921, S922, S926 and S927, and the rectangular area S924 corresponding to the front face of the cube 944 occluding part of the background plane 943. It is noted that the rectangular areas of image information corresponding to the sides of cube 944 would not be comprised in such a two-dimensional image. FIG. 10B illustrates a sequence of stripes that represents the three dimensional scene depicted in FIG. 10A for the primary view. The depicted sequence adds image information for side areas of cube 944, it does not add occlusion data, i.e. data elements of the background plane 943 occluded by the cube 944. The sequence of stripes in FIG. 10B consists of 7 stripes; S921, S922, S923, S924, S925, S926 and S297. The sequence of stripes is based on the three-dimensional scene as observed from the view indicated by arrow 941 in FIG. 10 A. The sequence of stripes corresponds to a scan path 942 left to right, top to bottom, along a horizontal scan direction as shown in FIG. 10A.

The stripes S921 and S927 represent rectangular areas of image information comprising data elements defining color and depth of part of the background plane 943 which in the two dimensional image would be respectively above and below the cube 944. Likewise the stripes S922 and S925 represent rectangular areas of image information of parts of the background plane 943 to the left and right of the cube 944 respectively. The stripes S923 and S925 represent rectangular areas of image information comprising data elements defining color and depth of two sides of the cube, along the scan path 942.

The sequence of stripes as established by the sequence generator (104) can be used to generate the signal directly, i.e. in the order determined by the scan path. The advantage of doing so is that image information needed for rendering a line is located in stripes in relatively close proximity.

Moreover stripes located adjacent in the scan direction could be clustered by splitting the sequence of stripes resulting in three sequences of stripes being: a first sequence corresponding to S921, a second sequence corresponding to the stripes S922, S923, S924, S925 and S926 and a third sequence corresponding to the stripe S927. Each of these sequences of stripes could be coded relative to one another such that only a horizontal offset is needed to indicate their respective position. However as can be seen in FIG. 10B, this does imply that image information from the background plane 943 and cube 944 will be interleaved.

Color, depth and position data elements may be coded together in one and the same stripe in the form of three or more valued tuples. Alternatively each of the different types of data elements may be coded in individual streams, thereby de-multiplexing the different types of data elements. In this manner a signal may be obtained that more closely resembles conventional image-and-depth representations.

FIG. 10C shows another representation that allows coding of information in a manner that more closely matches the image-and-depth format. By re-organizing the sequence of stripes from FIG. 10B it is possible to generate a signal wherein the stripes are ordered such that they together form the two-dimensional image as perceived from the primary view. In fact the information from these stripes could be combined into a new stripe 931 that corresponds to the two-dimensional image as observed from the viewpoint and view direction as indicated in FIG. 10A. The remaining stripes comprising image information from the side area would then be coded in the signal as a sequence of stripes S923 and S925 appended to the stripe 931.

Although for the sake of clarity no occlusion information was encoded in the above example, a preferred embodiment comprises both image information from side areas and occlusion areas. In this manner not only the sides of objects can be rendered more accurately for different views, but also de-occluded areas can be filled in with appropriate image information.

The above example included a cube in front of a background plane however the present invention may also be applied to more complex three dimensional scenes. In that case, the situation may occur that for certain regions of the rectangular area there is no image information available. This can be addressed in various manners, such as e.g. by adding a mask or transparency bit for those data elements.

An advantage of using stripes that correspond to rectangular areas of image information covering data elements of multiple video-lines, hereafter multi-line stripes, is that image information encoded in this manner can be compressed in a manner that takes into account spatial redundancy between pixels. The latter is particularly useful when using a compression scheme that uses a frequency domain transforms which address multiple data elements, such as an 8×8 DCT.

A further advantage of using multi-line stripes is that it allows the use of different sampling frequencies for color information and depth information. It may for example be possible to represent color information RGB at a first resolution and to use depth at a second resolution, e.g. at a quarter of the first resolution.

Although using multi-line stripes has certain advantages, it is also possible to use stripes that comprise data elements of a single video-line. Hereafter the present invention will be further elucidated primarily using examples of stripes comprising data elements of a single video line only for the sake of clarity.

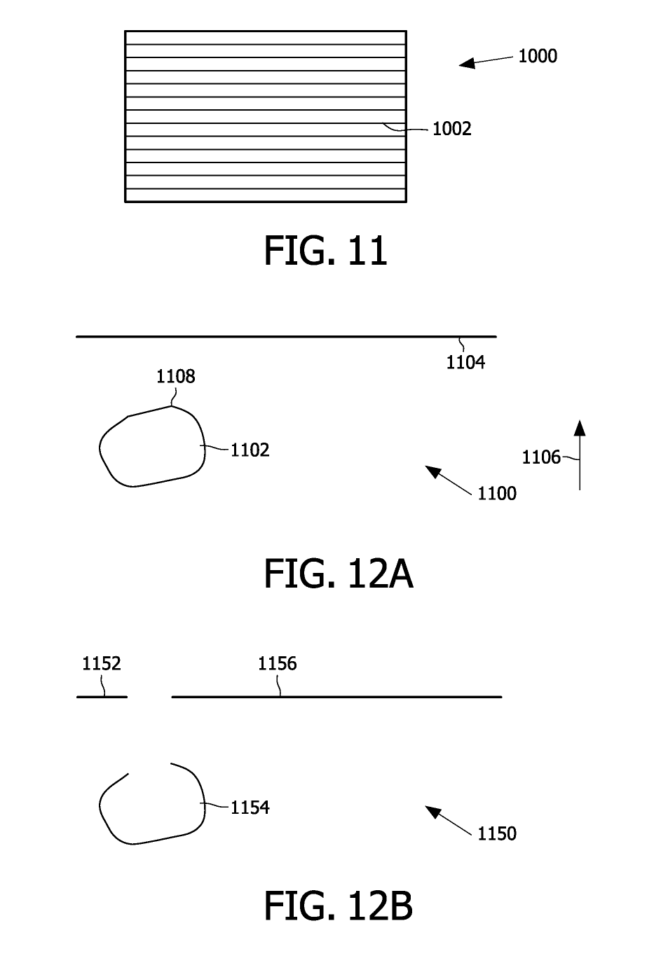

FIG. 11 illustrates schematically a video image 1000 with video lines 1002. The data 1350 for each video line 1002 of the image 1000 may be included in a video stream 1300 as illustrated in FIG. 14. Traditionally each line 1002 is a straight line which directly corresponds to pixels of a display. In the embodiments described below, these lines are extended to include three-dimensional information in a highly flexible manner. FIG. 12A illustrates a top view of a cross section 1100 of a three dimensional scene comprising an object 1102 and a background 1104. The signal to be generated preferably contains information to render images of the scene from viewing directions close to the direction of arrow 1106. The viewpoint may be a distance away from the scene and is not shown in the figure. The cross section 1100 corresponds to what may become visible at a horizontal video line 1102 during the rendering process.

System 100 comprises a contour generator 102 for generating at least part of the contours of the objects that are visible in the cross section 1100. Such a contour generator may be implemented in a way known in the art, for example using depth-from-motion algorithms or by using more than one camera to record the scene and applying depth computation techniques. Such algorithms may not be able to reconstruct the complete contour, especially the rear side 1108 of an object 1102 may not be visible in any of the images, and in such a case this portion of the contour information may not be available. Also, other parts of the scene may be occluded because of other objects in front of it. When more camera positions are used to record the scene, more contour information may become available. The contour 1154 in FIG. 12B indicates an example of the contours 1150 that may be available to the system. For example only part 1154 of the contour of the object 1102 is available for inclusion in the signal. Instead of contour generator 102, an input may be provided for receiving the information generated by the contour generator 102 from elsewhere.

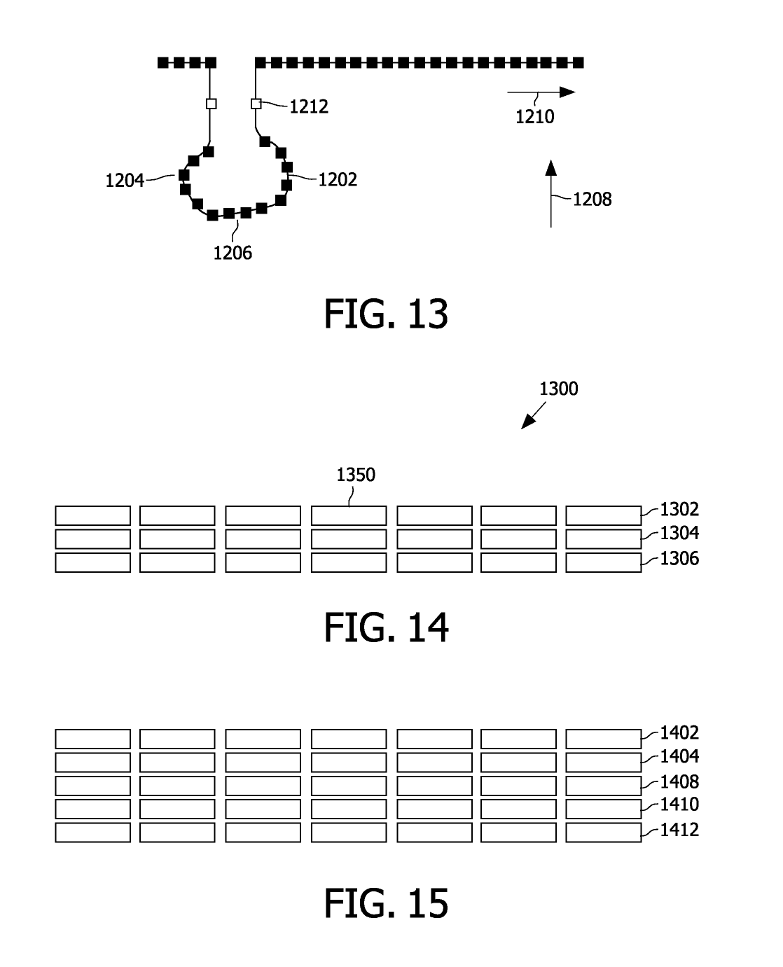

The system 100 further comprises a sequence generator 104 for generating a sequence of stripes defining at least part of the representation of the three dimensional scene from a view. Each stripe here represents a rectangular area of image information comprising data elements defining a color, a depth and a position of the rectangular area. In this line-based embodiment the rectangular area is considered to have a height of one data element. The sample points on the contour have associated with them various data elements such as color, depth and position that may be organized as tuples. All sample points shown in FIG. 13 may contribute to the video line 1002 as rendered for a particular view.

Most current multi-view displays render multiple views wherein the viewing direction for each of the views differs in the respective horizontal direction only. As a result rendering of images generally can be done in a line-based manner. As a result the video line 1002 preferably is a horizontal video line. However, the present invention may also be applied for video lines oriented in a vertical direction.

These sample points 1202 may be selected out of a plurality of segments of contours 1102 of the objects in the scene. The data elements associated with the sample points may be indicative of a color, for example expressed in red, green, and blue (RGB) components, or other formats known to those skilled in the art corresponding to the color of the object contour at the corresponding contour point. In case a more flexible solution is desired it is possible to allow the addition of further information such as e.g. a transparency data-element, which could be a binary, or a multi-value data-element, thus allowing the encoding of transparent or semi-transparent objects.

The data elements may also be indicative of a depth 1208. Such a depth may be expressed as a coordinate in the direction indicated by the arrow at 1208, i.e. providing information with regard to the distance to the view point. The depth may also be expressed as a disparity value, as known in the art. The depth as expressed corresponds to a particular primary view which corresponds to the viewing direction 1106 mentioned before. The viewing direction 1106 relates here to for example a direction of a line parallel to a line through the view point and the center of the background 1104. If the camera location is nearby the scene, the depth coordinates may correspond to divergent directions according to the projection of the scene onto the background. The data elements may also be indicative of a video line position 1210 in the direction indicated by the arrow at 1210. This video line position 1210 indicates a display position within the video line 1002 of the video image 1000, according to the primary view.

In particular when dealing with irregularly formed shapes it may be relevant to explicitly code the position and depth data elements associated with all sample points. In this manner it is possible to code any distribution of sample points with respect to the contour. For example data elements may relate to sample points chosen equidistant on the contour surface, or alternatively may be chosen equidistant with respect to a particular object contour normal. Alternatively, when coding more regular polygon structures, a more efficient position coding can be adopted, e.g. when using an equidistant sample grid on a polyline.

The sequence generator 104 selects consecutive points along the contour lines 1150. For example, if the video line is a horizontal line, the selector 104 may select the consecutive points from left to right. Alternatively the points may be selected from right to left. The selector 104 may start with the leftmost portion 1152 of the background, and work to the right until no information is present because of an object in front of the background. Then the selector 104 may continue with the contour of the object 1154. The selector may start at the left most endpoint of the contour 1154, work all the way along the contour 1154 until the right most endpoint is reached, and from there continue with the next object, which is in this case the remaining portion 1156 of the background.

The sequence generator 104 may be capable of including in the sequence of stripes a first subsequence, containing data elements of sample points near 1204, or consecutive data elements of sample points selected from a segment which is part of a side area of the at least one object 1102 in the primary view. The sequence generator 104 may also include a second subsequence, containing data elements of sample points near 1206, or consecutive data elements of sample points selected from a segment which is part of a frontal area of the at least one object in the primary view. The difference between the video line positions of two consecutive sample points of the first subsequence 1204 is smaller than a difference between the video line positions of two consecutive sample points of the second subsequence 1206. In this manner certain sequence portions are represented using data elements sampled at a higher sample frequency, to improve image quality of the rendered output, or alternatively at a lower sample frequency for the sake of representation size.

The sequence generator 104 may be arranged for including tuples indicative of one or more transparent data elements 1212 within a stripe to indicate a connection between different stripes. These transparent samples 1212 assist in efficiently rendering the sequence of stripes in a display system 150. For example a special data element may be included in the stripe, or in a tuple of data elements indicative of whether a piece of contour is transparent or not, alternatively a particular color value, or a color range may be reserved to indicate ‘transparent’. The use of a range may e.g. be particularly beneficial when the signal is subsequently subjected to lossy compression. The system 100 further comprises a signal generator 106 for generating a video signal comprising data elements comprised in the sequence of stripes 1350. This signal generator may be implemented in any way, as long as the sequence of stripes is appropriately encoded. Use may be made of digital signal encoding methods, such as MPEG standards. Other analog and digital signals, including storage signals and transmission signals, may be generated and are within the reach of the skilled person in view of this description. For example, the digital sequence of stripes may simply be stored in a file on a magnetic disc or on a DVD. The signal may also be broadcast via satellite, or cable TV, for example, or be transmitted via the Internet, or be transmitted on an interface like DVI or HDMI, to be received by a display system 150.

A plurality of respective sequences of stripes may be prepared and incorporated in the signal for a plurality of respective video lines 1002. This allows encoding a complete 3D video image 1000.

The several means 102, 104, and 106 may communicate their intermediate results via a random access memory 110, for example. Other architectural designs are also possible.

The system 100 also allows including samples from a segment which is occluded in the primary view and/or of rear areas of objects.

FIG. 14 illustrates schematically a transport stream comprising several data streams. Each horizontal row represents a data stream within the transport stream. Such transport stream may be generated by the signal generator 106. Alternatively, the signal generator 106 only provides the data streams for inclusion in a transport stream by a multiplexer (not shown). A block 1350 represents a sequence of stripes corresponding to a video line. The several blocks on a line correspond to sequences of stripes for different video lines of an image. In practice, these data blocks may be subject to compression methods which may combine multiple of these blocks into larger data chunks (not shown in the figures). The transport stream generated by the signal generator 106 may comprise a first data stream 1302 comprising the data elements indicative of colors of at least a first subset of the stripes. Moreover, a second data stream 1304 may comprise the data elements indicative of the depths of at least the first subset of the stripes. Consequently, the different data elements of the stripes may be transmitted in the signal separately. This may improve the compression results and helps to provide backward compatibility, because additional information as depth and/or horizontal position may be disregarded by legacy display equipment if they are included in an auxiliary data stream separate from the color information. Also, color and/or depth can be encoded using methods known in the art, leveraging developments in two-dimensional video coding, and allowing re-use of existing video encoders and decoders.

To further improve the compression ratio, the signal generator 106 may be arranged for aligning data elements in a first sequence of stripes with those in a second sequence of stripes, both sequences relating to a portion of the at least one object by inserting padding data elements. For example, consider the situation wherein the first sequence of stripes relates to a first video line and the second sequence of stripes relating to an adjacent video line. In this case the sequences may be aligned horizontally such that data element number N in the first sequence of stripes has the same horizontal position as data element number N in the second sequence of stripes.

When the sequence of stripes is encoded along a scan direction, the sequence of stripes can be encoded in a data stream by the sequence generator such that spatially adjacent data elements in the data stream are aligned with spatially proximate data elements in a direction perpendicular to the scan direction.

The signal generator 106 may further generate a third data stream 1306 which comprises the positions of at least the first subset of the stripes. These position values may be encoded as position values relative to a fixed reference point (for example corresponding to the left side of a video image). Preferably, the positions of consecutive samples are expressed as a delta (difference) between the video line positions of the consecutive samples. In the latter case the values may be efficiently compressed using run-length encoding, a well known lossless compression technique. However, compression is optional, and in situations wherein processing requirements are more critical than bandwidth, compression may not be necessary. For example, compression may not be necessary when using a display interface such as DVI or HDMI. In such a case, the delta values or the values relative to a fixed reference point may be encoded in uncompressed form, for example in two of the color channels, e.g. the green and blue channels, whereas the depth may be encoded in a third color channel, e.g. the red channel.

FIG. 15 illustrates another embodiment, in which backward compatibility is provided. To this end, a standard 2D video frame is encoded in a first stream 1402, analogous to the situation described with reference to FIG. 10C. This first stream 1402 may be compatible with legacy 2D displays. The corresponding depth values are stored in a second stream 1404. The combination of the first stream 1402 and second stream 1404 may be compatible with legacy 3D displays that can render image-and-depth video data. The horizontal positions (as in the third stream 1306 of FIG. 14) for the legacy 2D image may be omitted, because they are known a priori for standard video frames. However, in addition to the streams 1402 and 1404, the portions of the sequence of stripes not present in the image-and-depth streams 1402 and 1404, are included in one or more additional streams. In other words, the information represented by at least a second subset of the sequence of stripes is encoded in a different set of streams, wherein the first subset and the second subset are disjunct. The streams may relate to partially overlapping points, for example if a particular contour segment is represented in streams 1402 and 1404 at an insufficient resolution (e.g. image information related to a plane at an angle close to that of the viewing direction), the additional streams may provide a higher resolution version of that particular contour segment. For example, a further stream 1408 comprises the colors of at least the second subset of the sequence of stripes, a further stream 1410 comprises the depths of at least the second subset of the sequence of stripes, and a further stream 1412 comprises the horizontal positions of at least the second subset of the sequence of stripes.

It is also possible to extract other portions of the information for inclusion in one or more backwards compatible streams. For example, a plurality of image-and depth layers, or another layered depth images (LDI) representation, may be included in a backwards compatible stream; the remaining information not included in the backwards compatible stream and/or remaining information included in the backwards compatible stream in an unsatisfactory resolution may be included separately.

An embodiment comprises a signal 1300 representing a three dimensional scene from a primary view, the signal comprising a sequence 1350 of stripes defining at least part of the representation of the three dimensional scene from the view. Each stripe in turn represents a rectangular area of image information comprising data elements defining a color, a depth 1208 and a position 1210, wherein the color and depth data elements for each stripe are derived from surface contour information 1102 of at least one object in the scene. The position data element is derived from the position of the surface contour information of the at least one object within the view 1202 and at least one stripe 1204 of the sequence of stripes represents surface contour information of the at least one object selected from an occluded area or a side area of the at least one object in the scene.

The sequence of stripes comprises a first stripe 1204 of data elements associated with consecutive points selected from a segment which is part of an occluded area or a side area of the at least one object in the primary view and a second stripe 1206 of consecutive data elements selected from a segment which is part of a frontal area of the at least one object in the primary view. Also, a first difference between the horizontal positions of two consecutive position data elements of the first subsequence may be smaller than a second difference between the horizontal positions of two consecutive position elements of the second subsequence.

Referring to FIG. 1, display system 150 comprises an input 152 for receiving a signal representing a sequence of stripes as set forth. The display system 150 may receive this signal by reading it from a storage medium or via a network connection, for example.

The display system 150 further comprises an image generator 154 for generating a plurality of images corresponding to stereoscopic views using the sequence of stripes. The stereoscopic views have different viewing directions; i.e. they correspond with different views of the same three-dimensional scene. The views are preferably horizontally distributed, or at least along a horizontal direction. An image of the plurality of images may be generated as follows. First the position and depth data elements are transformed into video line positions and depths that correspond with the viewing direction and viewpoint of the image that is to be generated. Second, an image is rendered using these transformed values, wherein for any horizontal position only a depth value indicative of a position closest to the viewpoint needs to be taken into account. In effect, the sequence of tuples represents one or more 3D polylines, in case of line-based stripes or polygons in case of multi-line based stripes. These polylines may be rendered using z-buffering, as known in the art. For example, the data elements associated with the sequence of stripes may be rendered one by one, using z-buffering. The exact manner of rendering of the data elements does not limit the present invention.

The display system may comprise a display 156 for displaying the plurality of images. The display 156 may be an autostereoscopic slanted lenticular display, for example. The several images may be rendered on such a display in an interleaved way. Alternatively, two images can be displayed time-sequential, and shutter glasses may be used for proper 3D image perception by a human. Other kinds of display modes, including stereoscopic display modes, are known to the person skilled in the art. A plurality of images may also be displayed in sequence on either a 3D display or a 2D display, which may produce a rotating effect. Other ways of displaying the images, for example interactive virtual navigation through a scene, are also possible.

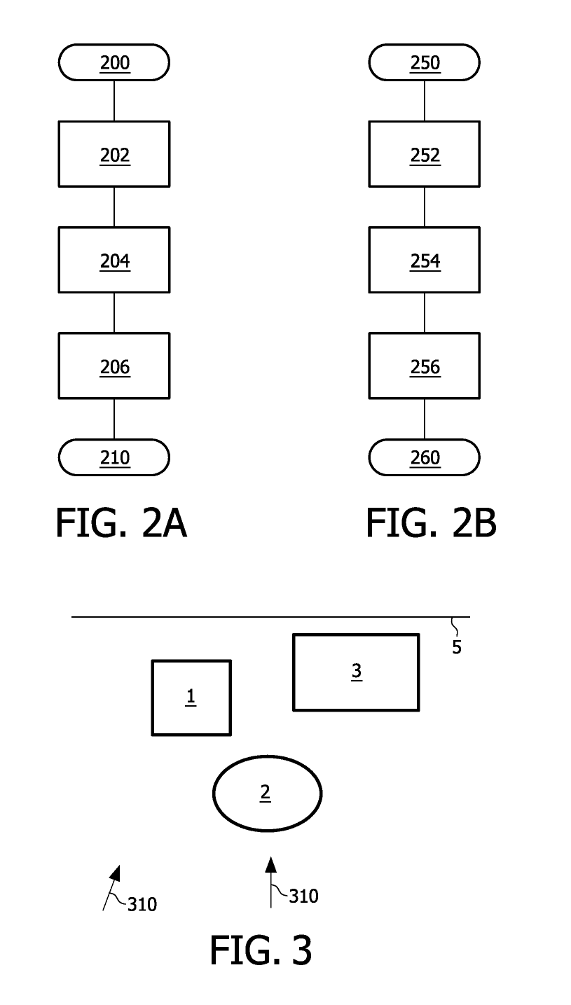

FIG. 2A illustrates processing steps in a method of generating a video signal. In step 200, the process is initiated, for example when a new video frame is to be processed. In step 202, the contour lines of the objects in the scene (including the background) are prepared as set forth. Instead of performing this step explicitly in the process, the result of step 202 may be provided as an input of the process.

In step 204, a sequence 1350 of stripes is generated defining at least part of the representation of the three dimensional scene from the primary view, wherein each stripe represents a rectangular area of image information comprising data elements defining a color, a depth 1208 and a position 1210. The color and depth data elements for each stripe are derived from surface contour information 1102 of the at least one object in the scene. The position data element is derived from the position of the surface contour information of the at least one object within the primary view 1202. Moreover, step 204 may involve including in the sequence of stripes a first stripe 1204 comprising data elements of consecutive points selected from a segment which is part of a side area of the at least one object in the primary view. A second stripe 1206 comprising data elements of consecutive points may be selected from a segment which is part of a frontal area of the at least one object in the primary view. A first difference between the horizontal positions of two consecutive position data elements of the first subsequence may be smaller than a second difference between the horizontal positions of two consecutive position data elements of the second subsequence.

Steps 202 and 204 may be repeated for a plurality of video lines in the image. In step 206, a video signal is generated including the resulting sequence or sequences of samples. In step 210, the process terminates. As indicated earlier the method can be applied for line based sequences of stripes and multi-line based sequences of stripes alike. The step 202 may be performed as follows. A plurality of images of the at least one object as seen from a plurality of different views is received. Depth information is established for pixels of the plurality of images, or may be provided as additional input, e.g. depth values determined using a range finder. The pixels of the secondary views are warped to the primary view, such that information indicative of a depth and a horizontal position according to the primary view of the at least one object is obtained for the pixels. This way, contour information is obtained.

FIG. 2B illustrates a method of rendering an image on a display. In step 250 the process is initiated, for example because a new video frame needs to be prepared for display. In step 252, a signal comprising a sequence (1350) of stripes is received as set forth. In step 254, a plurality of images is generated corresponding to stereoscopic views using the sequence of stripes. In step 256, the plurality of images is displayed as set forth.

The processes and systems described herein may be implemented in part or completely in software.

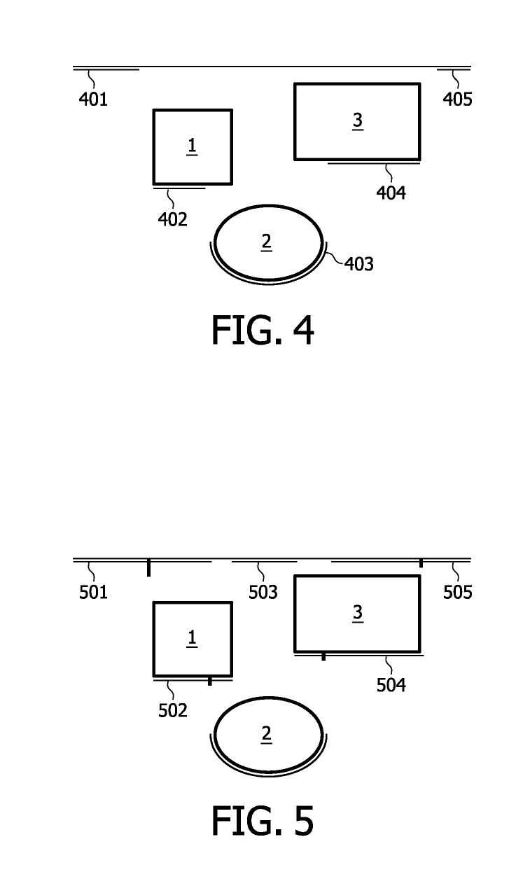

FIG. 3 shows a cross sectional top-view of a scene with three objects 1, 2, and 3, in front of a background plane 5. When viewing the objects 1, 2, 3 and the background plane 5 in the direction of arrow 310, the image-and-depth format would store the information indicated at 401-405 in FIG. 4, as a per-pixel color and depth. Alternate views can be generated from this representation, but when observing the scene at a different viewing angle, e.g. in the direction indicated by arrow 320, the image-and-depth representation does not contain the information necessary to really “look around” objects and see what becomes visible; i.e. what is de-occluded, such as the right part of the front of object 1 which would become visible when looking from a position more to the left than the original position, or part of the background which might be visible when looking from the right between objects 2 and 3.

FIG. 5 illustrates a partial solution to this problem by using multiple layers of image and depth. For example, two layers of image-and-depth may be used. FIG. 5 shows at 501-505 the extra information which could be stored in a second layer for the present example. The complete front-facing sides of objects 1 and 3 can now be stored, but three layers would be required to also store the complete background. Furthermore, it is difficult to define the sides of the objects (for example objects 1 and 3) using a representation which uses a fixed horizontal spacing with respect to a central view. Also the rear-facing sides of objects are not stored with this representation. Storing image-and-depth from multiple views could be a solution, but then keeping their relationships intact under compression of the depth signal is difficult and requires complex computations, furthermore transparency is hard to support with such a representation, unless either many views are used, or multiple layers are provided for the multiple views, which may require many layers and hence a lot of storage space.

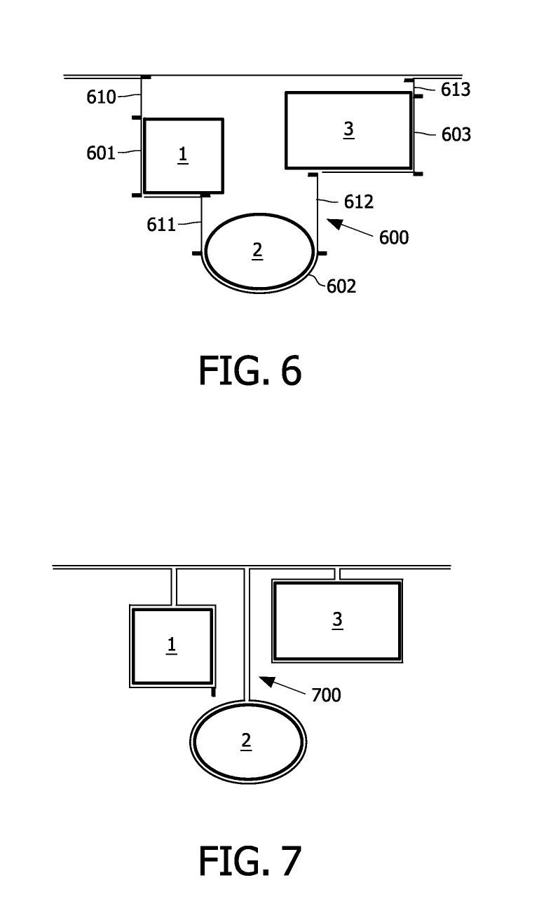

FIG. 6 illustrates a way of organizing image data as a kind of drape 600. With such a drape 600, a contour description of the scene may be provided in an efficient and scalable manner. Such a drape 600 metaphorically behaves like a sheet which is draped around the objects 1-3 and background 5 of the scene. FIG. 6 shows a configuration when the drape 600 is loosely draped over the scene.

The drape 600 describes the contour line along the surfaces of the objects in the scene. Preferably such a contour line is completely within a cross section of the scene. The drape 600 not only comprises parts of the contour line which are frontal sides 602 of the objects, but also the left side 601 of object 1 and the left side of object 2, as well as the right side 603 of object 3 and the right side of object 2. Consequently, compared to the image-and-depth format, more occlusion data is captured. Some parts of the drape 600 contain image data. Examples of this are parts 601, 602, and 603. Other parts of the drape 600 are transparent. An example of a transparent part is part 610, 611, 612 and 613. Such a transparent part does not require a lot of storage space. For example, such a part may be skipped altogether. Preferably an indication is inserted in the signal to indicate that a portion of the drape is transparent. Alternatively, when a distance between successive pieces of drape is above a predetermined threshold, the portion in between the successive pieces of drape is set to transparent.

FIG. 7 illustrates that more occlusion data may be captured in the drape representation. Metaphorically, the drape can be fit tighter around the objects of the scene. In FIG. 7 the drape 700 is tightened so far that the full contours of the objects are traversed, which provides most flexibility in generating stereoscopic views. Intermediate amounts of tightening, in between the situations of FIG. 6 and FIG. 7, are also possible.

Next to the amount of tightening, also the resolution at which information is stored along the drape can be varied to balance the amount of information and storage/transmission capacity. The “transparent” parts mentioned earlier are an extreme example of this, but one could also choose to, for example, encode the sides of the objects (and especially the rear of the objects) at lower resolutions. The drape then may consist of a series of data elements associated with equidistant or non-equidistant points. These data elements may include information about color and possibly also transparency. Optionally additional information may be included to capture view-direction dependent effects, such as bi-directional reflectance distribution data, may also be included, as well as any other relevant information. The samples may have associated coordinates (x and z for a drape as shown in the figures, and a series for each line when a full 3D image is represented). Different methods can be used to store these series. Chain codes might be used, in particular if lossless compression is used.

It is possible to retain vertical cohesion for subsequent horizontal drape-lines. This allows achieving good compression performance. For example, the regular image-and-depth representation may be extracted or stored separately, and the additional pieces of the drape (which can be inserted back into the image-and-depth samples) may be stored as additional data. This ensures backwards compatibility with the current image-and-depth format, and adds the full drape-data as an optional extra. Moreover, the regular image-and-depth representation may be compressed using high-performance compression techniques. The remaining pieces in the additional data can then be arranged such that vertical cohesion is maximized for optimal compression. If the drape-lines correspond to vertical video lines, horizontal cohesion may be retained in a similar fashion.

A drape representation can be constructed from the images (and possibly depths) of several cameras looking at the scene from different positions, or can for example be derived from a voxel representation obtained by slicing through a (virtual) scene. Rendering a view from a drape may be realized by means of a process of depth-dependent shift with proper occlusion and de-occlusion handling.

In the field of computer graphics, boundary representations are known, such as for example described in “Relief texture mapping” by M. M. Oliveira et al., in Proceedings of the 27th annual conference on Computer graphics and interactive techniques, pages 359-368, 2000, ISBN 1-58113-208-5. These computer graphics representations are usually very geometrical in nature (for example mesh-based), whereas the drape may be used in a video-like representation in which not only colors but also depths may be represented as video signals which can be compressed very well.

It is also possible to encode vertical de-occlusion information using the technology described herein. For example, one or more sequences of samples may have vertical positions instead of horizontal positions associated with it. These “vertical drape lines” can be used instead of or in addition to the “horizontal drape lines”. Alternatively, the vertical spacing between successive sequences of samples may be made variable to accommodate visualizing an upper and/or a lower edge of an object.

A “drape” may be described as a sequence of stripes. These stripes may comprise a color value, a horizontal position value (e.g. pixel number on a line of a primary view), a depth value or disparity value, and/or a transparency indicator or value. It will be apparent that a color is not needed for a fully transparent portion or that a particular color value may be reserved for indicating “transparent”. Sides of a cube with a front side normal close to the viewing direction will be described using successive tuples having (either almost or exactly) the same position p, but different d, and appropriate color values. Objects which are in front of each other may be connected by means of a transparent portion of the drape. Using a “loose drape”, only frontal surfaces and side surfaces of objects are described in the drape. Using a “tight drape”, also the back surfaces of objects are described in the drape. In many cases, some side and rear surface information is present, but not all information. The drape can be used to accommodate any information available. It is not necessary to waste storage space for information which is not available or which is not needed at the receiving end. Also, it is not necessary to store redundant data. In video encodings using multiple layers, some storage space may be wasted if there is not enough information available to fill all layers, even after compression.

Using for example three images (a left, middle, and right image) of the same scene taken by three adjacent cameras (a left, middle, and right camera), it is possible to consolidate the information of the three images into a single drape. First, the depth map is reconstructed for all three images. Stereoscopic computations involving for example camera calibration may be employed. Such computations are known in the art. Next, the right and left images are warped to the geometry of the middle image. Surfaces appearing in the warped left image, the warped right image, and the middle image may be stitched together by detecting overlapping or adjacent surface areas. Next, the drape lines may be constructed by sampling or selecting from these (warped) image points.

To maintain vertical consistency, it is possible to insert transparent samples. This improves compression ratios obtained when using known video compression techniques.

Rendering of a drape line may be performed in a way similar to rendering a 3D polyline using z-buffering.

The sequences of samples representing the drape lines may be stored in a number of images. The first image may comprise color information. It is also possible to encode each of the components such as R, G, and B, or Y, U and V as three separate images. It is also possible to convert the colors to for example YUV color space which can be compressed better by subsampling U and V, as is known in the art. The second image may comprise depth information. This depth information may be encoded by means of a coordinate or by means of disparity information, for example. The third image may comprise horizontal coordinates: the video line position, for example expressed in whole pixels, or alternatively using an indication allowing sub-pixel precision (e.g. a floating point value). These images may further be compressed using standard video compression. Preferably, the image containing the x-coordinates may be expressed in deltas: the difference between the x-coordinates of consecutive samples may be stored instead of the absolute values of the x-coordinates. This allows performing efficient run-length encoding compression. These images may be stored in separate data streams.

Preferably, backward compatibility is provided by extracting a regular 2D image with optional depth information, to be stored or transmitted separately as a conventional video stream. The depth image may be added as an auxiliary stream. The remaining portions of the sequences of samples may be stored in one or more separate streams.

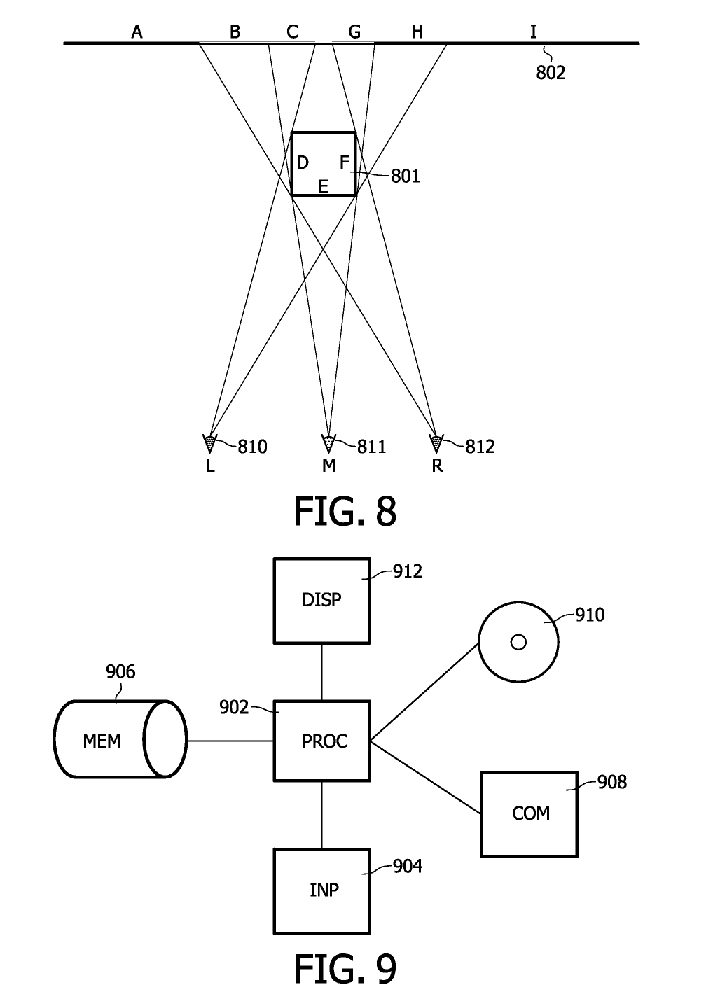

FIG. 8 illustrates a scene comprising a cube 801 and a background 802. The scene is captured using three camera locations 810, 811, and 812. FIG. 8 illustrates specifically what is captured using the left camera 810. For example, the left camera captures contour segments A, B, C, D, E, and I, but not contour segments F, G, and H.

The image data of two of the cameras may be warped to the third camera position, e.g. the leftmost and rightmost images may be warped to the middle camera, which changes the x-values of the pixels of the warped images. It may happen, as is the case for the side surface of the cube object in FIG. 8, that several pixels have the same x-value (but with different depth value). It is even possible that the x-values of such a warped image are non-monotonic, in particular if the left camera sees a portion of an object which is a rear surface of an object in the middle camera's view. These side and rear portions can be effectively stored in the sequence of tuples (the “drape”) as described in this description. The resolution in which such side or rear portions are stored may depend on the number of pixels allocated to the side or rear portion in the available views.

FIG. 9 illustrates an example hardware architecture for implementing part of the methods and systems described herein in software. Other architectures may also be used. A memory 906 is used to store a computer program product comprising instructions. These instructions are read and executed by a processor 902. An input 904 is provided for user interaction possibilities, for example by means of a remote control or a computer keyboard. This may be used for example to initiate processing of a sequence of images. The input may also be used to set configurable parameters, such as the amount of depth perception, the number of stereoscopic images to produce, or the amount and resolution of occlusion data to be included in a video signal. A display 912 may be helpful for implementing the interaction possibilities in a user friendly way by providing a graphical user interface, for example. The display 912 may also be used to display the input images, output images, and intermediate results of the processing described herein. Exchange of image data is facilitated by a communications port 908 which may be connected to a video network (digital or analog, terrestrial, satellite, or cable broadcast system for example) or the Internet. Data exchange may also be facilitated by a removable media 910 (a DVD drive or a flash drive, for example). Such image data may also be stored in the local memory 906.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system (100) for generating a signal (1300) representing a three dimensional scene from a primary view, comprising:
a sequence generator (104) for generating a sequence (1350) of stripes defining at least part of the representation of the three dimensional scene from the primary view, each stripe representing a rectangular area of image information comprising data elements defining a color, a depth (1208) and a position (1210) of the rectangular area, wherein
the color and depth data elements for each stripe are derived from surface contour information (1102) of at least one object in the scene;
the position data element is derived from the position of the surface contour information of the at least one object within the primary view and
at least one stripe (1204) of the sequence of stripes represents surface contour information of the at least one object selected from an occluded area or a side area of the at least one object in the scene; and
a signal generator (106) for generating a video signal comprising the sequence of stripes.

2. The system according to claim 1, wherein the color, depth and position data elements comprised in each stripe are grouped as tuples of color, depth and position data elements.

3. The system according to claim 1, wherein the sequence generator is arranged for including in the sequence of stripes a stripe representing surface contour information from a rear side area of the at least one object in the primary view.

4. The system according to claim 1, wherein the signal generator is arranged for generating a transport stream, the transport stream comprising:
a first data stream (1302) comprising the color data elements of at least a first subset of the sequence of stripes; and
a second data stream (1304) comprising the depth data elements of at least the first subset of the sequence of stripes.

5. The system according to claim 4, wherein the transport stream further comprises:
a third data stream (1306) comprising position data elements of at least the first subset of the sequence of stripes.

6. The system according to claim 4, wherein the sequence of stripes encoded in a data stream (1302, 1304) is encoded in a scan direction and the sequence generator is arranged to add padding data elements in the data stream (1302, 1304) to align spatially adjacent data elements in the at least one of the first data stream and the second data stream in a direction perpendicular to the scan direction.

7. The system according to claim 1, wherein the color data elements are represented at a first resolution and the depth data elements are represented at a second resolution and wherein at least one of the x-component or the y-component of the first resolution is higher than that of the second resolution.

8. The system according to claim 1, wherein:
color and depth data elements comprised in each stripe are grouped as tuples of color and depth data elements;
color and depth data elements comprised in each stripe are placed on an equidistant grid; and
the position data element indicates a position of the surface contour information of the stripe along a scan direction within the primary view.

9. The system according to claim 4, wherein the transport stream further comprises at least one of:
a data stream comprising the color data elements of at least a second subset of the sequence of stripes;
a data stream comprising the depth data elements of at least the second subset of the sequence of stripes; and
a data stream comprising the position data elements of at least the second subset of the sequence of stripes;
wherein the first subset and the second subset are disjunctive.

10. A rendering system (150) for rendering an image using a signal representing a three dimensional scene from a primary view, comprising:
an input (152) for receiving the signal comprising a sequence (1350) of stripes defining at least part of the representation of the three dimensional scene from the primary view, each stripe representing a rectangular area of image information comprising data elements defining a color, a depth (1208) and a position (1210) of the rectangular area, wherein
the color and depth data elements for each stripe are derived from surface contour information (1102) of at least one object in the scene;
the position data element is derived from the position of the surface contour information of the at least one object within the primary view and
at least one stripe (1204) of the sequence of stripes represents surface contour information of the at least one object selected from an occluded area or a side area of the at least one object in the scene and
an image generator (154) for rendering the image corresponding to a further view using the sequence of stripes.

11. The rendering system according to claim 10, wherein the image generator is arranged for generating a plurality of stereoscopic images corresponding to a plurality of stereoscopic views using the sequence of stripes.

12. A display system for displaying an image using a signal representing a three dimensional scene from a primary view, comprising:
a rendering system according to claim 10 and
a display (156) for displaying the rendered image.

13. A signal (1300) representing a three dimensional scene from a primary view, the signal comprising a sequence (1350) of stripes defining at least part of the representation of the three dimensional scene from the primary view, each stripe representing a rectangular area of image information comprising data elements defining a color, a depth (1208) and a position (1210) of the rectangular area, wherein
the color and depth data elements for each stripe are derived from surface contour information (1102) of at least one object in the scene;
the position data element is derived from the position of the surface contour information of the at least one object within the primary view and
at least one stripe (1204) of the sequence of stripes represents surface contour information of the at least one object selected from an occluded area or a side area of the at least one object in the scene.

14. A method (100) of generating a signal (1300) representing a three dimensional scene from a primary view, comprising:
generating a sequence (1350) of stripes defining at least part of the representation of the three dimensional scene from the primary view, each stripe representing a rectangular area of image information comprising data elements defining a color, a depth (1208) and a position (1210) of the rectangular area, wherein
the color and depth data elements for each stripe are derived from surface contour information (1102) of at least one object in the scene;
the position data element is derived from the position of the surface contour information of the at least one object within the primary view and
at least one stripe (1204) of the sequence of stripes represents surface contour information of the at least one object selected from an occluded area or a side area of the at least one object in the scene; and
generating a video signal comprising the sequence of stripes.

15. The method according to claim 14, further comprising:
receiving a plurality of images of the at least one object as seen from multiple views;
establishing depth information for pixels of the plurality of images;
warping the image information of the plurality of viewpoints, including the color, depth and position data elements to the primary view, such that information indicative of color, depth and position according to the primary view is obtained for use in generating the sequence of stripes.

16. A method of rendering an image using a signal representing a three dimensional scene from a primary view, comprising:
receiving the signal comprising a sequence (1350) of stripes defining at least part of the representation of the three dimensional scene from the primary view, each stripe representing a rectangular area of image information comprising data elements defining a color, a depth (1208) and a position (1210) of the rectangular area, wherein
the color and depth data elements for each stripe are derived from surface contour information (1102) of an object in the scene;
the position data element is derived from the position of the surface contour information of the object within the primary view and
at least one stripe (1204) of the sequence of stripes represents surface contour information of the object selected from an occluded area or a side area of the at least one object in the scene and
rendering the image corresponding to the primary view using the sequence of stripes.

17. A computer program product comprising machine readable instructions for causing at least one processor to perform the method according to claim 14.
